(19) United States
(12) Patent Application Publication
(10) Pub. No.: US 2003/0128001 A1
(43) Pub. Date: Jul. 10, 2003

(54) Drive unit comprising a device for the controlled and/or modulated gradual slow down and shut-down of a funicular

(76) Inventors: Otto Pabst, Viptieno (IT); Nikolaus Erharter, Vipitgno (IT)

Correspondence Address: Shlesinger Fitzsimmons & Shlesinger, 183 East Main Street, 1323 Alliance Building, Rochester, NY, 14604, US

(21) Appl. No.: 10/258,916

(22) PCT Filed: May 16, 2001
(86) PCT No.: PCT/EP01/05620

(30) Foreign Application Priority Data
May 18, 2000 (IT) BZ2000A000025

(51) Int. Cl. H02J 7/00

(52) U.S. Cl. 318/105; 307/64

(57) ABSTRACT

A motive installation with equipment for the regulated and/or modulated disconnection and stopping of a cableway comprising an electric motor (12,34) connected to actuation of the cableway with an electric mains system (2) being connected electrically to the motor is described.

In accordance with the present invention the equipment comprises a first frequency converter (4) arranged between the motor (12,34) and the mains connection (2) with a first regulator (5) being connected to the outlet of the first frequency converter (4) with entry of the frequency converter (4) with a line (8) connected to devices detecting operation of the cableway installation and with at least a second frequency converter (10,24,27) respectively influenced by a regulator (11,36,37) with the outlet of the at least one second frequency converter (10,24,27) being connected to the electric motor (12) with between the first (4) and at least second frequency converter (10,24,27) there being shunted at least one power supply of an electric power source designed to operate for a predetermined time and upstream of such shunt there being inserted a shunt (16,22,29) designed to be controlled in opening upon power failure or by the braking or stopping program of the installation.

The present invention relates to a motive installation with equipment for the regulated and/or modulated disconnection and stopping of a cableway in accordance with the classifying part of claim 1.

In installations of this kind a solution is often sought in which it would not be necessary to employ a reduction mechanism, motor and drive pulley and hence there would be no power transmission from a motor to a transmission mechanism. In addition it is sought to reduce ever more the number of moving parts and those subject to wear. Maintenance should be reduced to the minimum and noise development should be limited. Efficiency should be high with high cos φ and minimum pollution of the mains.

To achieve these results direct actuators were recently realized in cableway installations, i.e. installations in which gear motors were no longer necessary.

The disadvantage of an installation of this kind is that rotating masses are lacking to carry out a quite different braking behavior of the installation compared with conventionally functioning installations. In the case of cableways in steep installations with high hourly burden because of the lacking rotating masses, very high lag can occur so that the maximum braking delays preset by the standard with very high load can no longer be respected with upward load.

Now there are several ways of solving this problem.

The mass of the driving pulley can be increased so that lag again reaches the required values, and

an intermediate mechanism with one or more stages can be inserted between the motor and the driving pulley and in this case there would no longer be an actual direct drive.

The general purpose of the present invention is to remedy the above mentioned shortcomings represented by direct drives and make braking, for example in case of failure of electric power, such as to achieve a braking path with a maximum speed as prescribed by the standards without providing supplementary inertial masses or flywheels.

This purpose is achieved in accordance with the present invention in a motive installation having equipment for regulated disconnection control and stopping of a cableway having the characteristics of the characterizing part of claim 1.

Thus in accordance with claim 1 deceleration of the installation can be actively influenced by supplying power to the installation so that it can be controlled in disconnection depending on speed and the path of deceleration-stopping is predetermined by the motor. Upon deceleration or stopping of the installation the control or adjustment is distinguished, if the installation conveys upward (with motor) or downward (with generator). In case of generator operation braking is performed as heretofore. In motor operation the installation is stopped in accordance with the following plan.

Stopping of the installation with the operating drive motor functioning without problems as long as the mains supply power,

if power supply fails (mains, generator) the power necessary for disconnection or slowing of the installation is taken from an independent power source and the motor stops the installation in accordance with a predetermined slope from the supply of the independent power source,

in a parallel embodiment under safety consideration this power source and the respective adjustment can be made redundant, or even in such a manner that for example in the case of nonfunctioning of one of the power sources another power source intervenes, and

at a minimal speed the normal mechanical parking brake operates.

Additional characteristics and details of the installation in accordance with the present invention are given in the following description of two preferred embodiments shown in the annexed drawing in which:

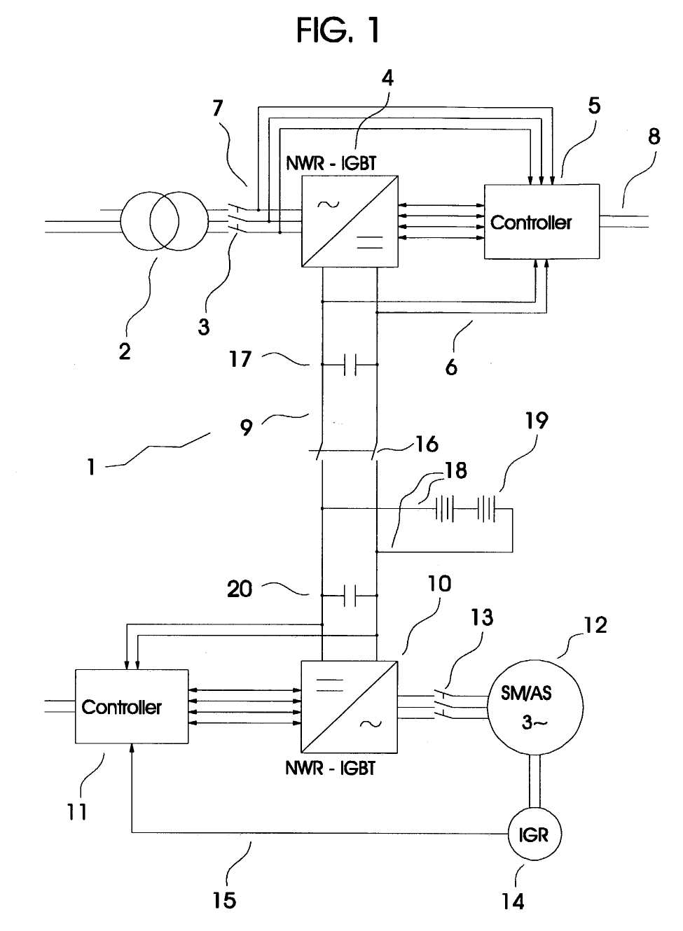

FIG. 1 shows an electrical diagram of a installation in accordance with the present invention in a first embodiment, and

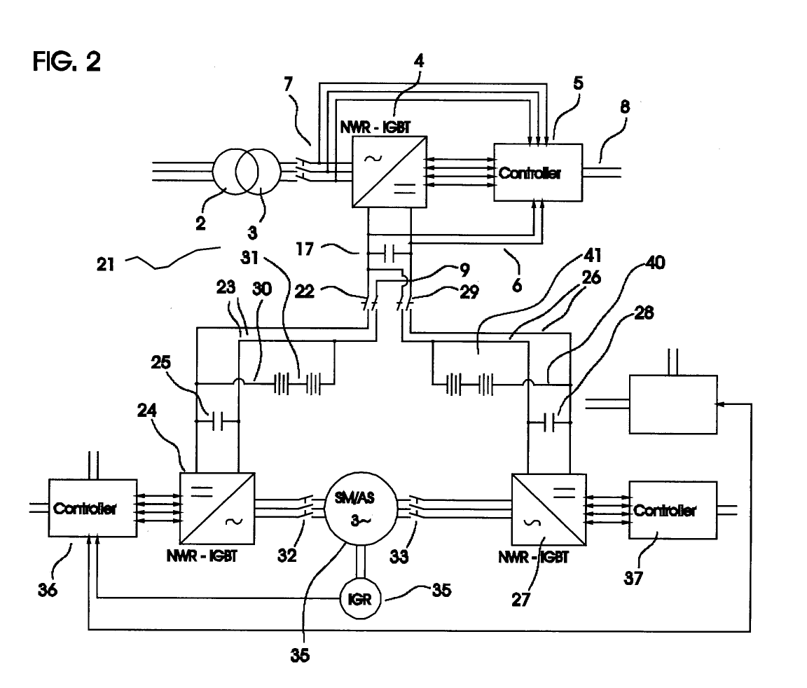

FIG. 2 shows an electrical diagram of an installation in accordance with the present invention in a second embodiment in redundant execution.

With reference to the figures, reference number 1 designates as a whole a diagram of the equipment of a motive installation for the control of regulated disconnection and stopping of a cableway.

The equipment 1 is connected to 3-phase mains 2 through a main switch 3. The equipment 1 comprises a frequency converter 4 controlled by a regulator 5. The regulator 5 is connected through a line 6 to the output of the frequency converter 4 and with inlet 7 of the frequency converter. It is also connected by the line 8 to devices designed to detect the speed, braking et cetera of the motive installation.

The frequency converter 4 is also connected electrically to a frequency converter 10 which is reversed with respect to the frequency converter 4 which is also controlled by a regulator 11 and powered as the regulator 5 and with a motor 12 with interposition of a switch 13. The motor 12 is connected directly with an actuator 14 of the motive installation. The actuator 14 is connected through a feedback line 15 to the regulator 11.

In accordance with the present invention between the frequency converter 4 and the frequency converter 10 there is a switch 16 with an interposed capacitor 17 downstream from which is a shunt 18 connected to an electric power source 19. The latter can appropriately be a rechargeable battery or a block of condensers of the conventional type. Downstream from the shunt 18 there is a capacitor 20.

In FIG. 2 the components coinciding with those of FIG. 1 have the same reference numbers and are not further described. In line 9 indicated above with reference to FIG. 1 is inserted downstream from the capacitor 17 a double switch 22 designed to contact a line 23 connected to a frequency converter 24 with an interposed capacitor 25. Between the double switch 22 and the capacitor 25 a shunt 30 is applied to the line and connected to a power source 31 of the same type as 19 of the first embodiment and thus not further explained. In line 9 is also inserted downstream of the capacitor 17 a switch 29 acting independently of the double switch 22 and designed to contact a line 26 connected to a frequency converter 27 with interposed capacitor 28. Between the double switch 29 and the capacitor 28 to the line 26 is applied a shunt 40 connected to a second power source 41 of the same type as 19 of the first embodiment and thus not further explained.

The converter 24 is connected to an electric motor 34 either synchronous or asynchronous while the frequency converter 27 is connected through a switch 33 to the same electric motor 34.

The electric motor 34 drives an actuator diagrammed at 35. The frequency converter 24 is influenced by a regulator 36 while the frequency converter 27 is influenced by a regulator 37 of the same type as the regulator 8.

For both embodiments the electric power source is sized so as to supply supplementary power in the absence of mains current in accordance with a ramp such as to not exceed a maximum prescribed deceleration with a value varying with each different type of installation, for example 1.25 m/s² for continuously moving installations.

1. Motive installation with equipment for the regulated and/or modulated disconnection and stopping of a cableway comprising an electric motor (12,34) connected to actuation of the cableway with an electric mains system (2) being connected electrically to the motor characterized in that it comprises a first frequency converter (4) arranged between the motor (12,34) and the mains connection (2) with a first regulator (5) being connected to the outlet of the first frequency converter (4) with entry of the frequency converter (4) with a line (8) connected to devices detecting operation of the cableway installation and with at least a second frequency converter (10,24,27) respectively influenced by a regulator (11,36,37) with the output of the at least one second frequency converter (10,24,27) being connected to the electric motor (12) with between the first (4) and at least second frequency converter (10,24,27) there being shunted at least one power supply of an electric power source designed to operate for a predetermined time and upstream of such shunt there being inserted a shunt (16,22,29) designed to be controlled in opening upon power failure or by the braking or stopping program of the installation.

2. Installation in accordance with claim 1 characterized in that the power source is a battery.

3. Installation in accordance with claim 1 characterized in that the power source is a block of capacitors.

4. Installation in accordance with claim 1 characterized in that the electric motor is a synchronous electric motor.

5. Installation in accordance with claim 1 characterized in that the electric motor is an asynchronous electric motor.

6. Installation in accordance with claim 1 characterized in that the shunt power source is sized in such a manner that the power supply therefrom responds to a ramp bearing the cableway running speed below a maximum deceleration for braking.
